(19) United States
(12) Patent Application Publication
(10) Pub. No.: US 2019/0056240 A1
(43) Pub. Date: Feb. 21, 2019

(54) SELF-CONFIGURING SENSOR ARRAY

(71) Applicant: BAE SYSTEMS Information and Electronic Systems Integration Inc., Nashua, NH (US)

(72) Inventor: Michael Jay Bear, Falls Church, VA (US)

(73) Assignee: BAE SYSTEMS Information and Electronic Systems Integration Inc., Nashua, NH (US)

(21) Appl. No.: 15/677,342

(22) Filed: Aug. 15, 2017

(51) Int. Cl. G01D 3/036; G01D 11/30

(52) U.S. Cl. CPC G01D 3/036; G01D 11/30

(57) ABSTRACT

Techniques are provided for self-configuration of a sensor array. A methodology implementing the techniques according to an embodiment includes deploying a number of mobile sensor elements from a base unit to a region of interest. The method also includes transmitting an initial sensor configuration plan from the base unit to the sensor elements. The mobile sensor elements navigate to a calculated location based on the initial sensor configuration plan. Sensor data is collected by each of the elements and transmitted back to the base unit for data integration. The method further includes performing, by the base unit, a response analysis using the integrated sensor data and updating the initial sensor configuration plan based on a metric associated with the response analysis. The method further includes iterating these operations to employ the updated sensor configuration plan. Additional iterations are performed until the metric reaches a selected threshold value.

### FIELD OF DISCLOSURE

The present disclosure relates to sensor arrays, and more particularly, to techniques for autonomous self-configuration of sensor arrays to provide dynamic adaptation.

### BACKGROUND

Signal collection systems often employ multiple sensors to improve reception. These sensors are typically arranged in a fixed pattern that is configured to provide generally acceptable receiver performance. These fixed patterns, however, limit the responsiveness of the receiver to varying parameters that may be associated with different signals of interest. For example, signals may exhibit variations in signal power versus angular distribution, and a fixed sensor geometry will not provide an optimal response for all cases.

### BRIEF DESCRIPTION OF THE DRAWINGS

Features and advantages of embodiments of the claimed subject matter will become apparent as the following Detailed Description proceeds, and upon reference to the Drawings, wherein like numerals depict like parts.

FIG. 1 illustrates a self-configuring sensor array system prior to sensor deployment, in accordance with certain embodiments of the present disclosure.

FIG. 2 illustrates an initial deployment of the self-configuring sensor array, in accordance with certain embodiments of the present disclosure.

FIG. 3 illustrates a reconfiguration of the self-configuring sensor array, in accordance with certain embodiments of the present disclosure.

FIG. 4 is a block diagram of a sensor deploying base unit, configured in accordance with certain of the embodiments disclosed herein.

FIG. 5 is a block diagram of a mobile sensor element, configured in accordance with certain of the embodiments disclosed herein.

FIG. 6 is a flowchart illustrating a methodology for sensor array self-configuration, in accordance with certain of the embodiments disclosed herein.

FIG. 7 is a block diagram schematically illustrating a platform configured to support a self-configuring sensor array, in accordance with certain of the embodiments disclosed herein.

Although the following Detailed Description will proceed with reference being made to illustrative embodiments, many alternatives, modifications, and variations thereof will be apparent to those skilled in the art.

### DETAILED DESCRIPTION

Generally, this disclosure provides techniques for autonomous self-configuration of sensor arrays. Mobile sensor elements are configured with propulsion capabilities enabling them to navigate to calculated locations to assemble into a specified geometric pattern or configuration. The pattern is evaluated, based on measurements of a received signal of interest through the sensor array, and a new configuration (e.g., an update to the pattern) may be generated and tested based on the results of the evaluation. The sensor reconfiguration and reevaluation process may be repeated as needed until a desired level of performance is reached, as will be explained below.

The disclosed techniques can be implemented, for example, in a computing system or a software product executable or otherwise controllable by such systems, although other embodiments will be apparent. The system or product is configured to provide a self-configuring array of sensor elements. In accordance with an embodiment, a methodology to implement these techniques includes deploying a number of mobile sensor elements from a base unit to a region of interest. The method also includes transmitting an initial sensor configuration plan from the base unit to the sensor elements. The mobile sensor elements are configured to navigate to a calculated location based on the initial sensor configuration plan. In some embodiments, the navigation process employs inter-sensor communication, for example to reduce congestion and avoid collision between mobile sensor elements, and to ensure accurate position and spacing of the sensors in the resulting configuration. Sensor data is collected by each of the elements and transmitted back to the base unit for data integration. The method further includes performing, by the base unit, a response analysis using the integrated sensor data and updating the initial sensor configuration plan based on a metric associated with the response analysis. The operations are repeated using the updated sensor configuration plan. Additional iterations are performed until the metric indicates that a desired level of performance of the sensor array has been achieved. In some embodiments, transmitter elements may supplement (or substitute for) the sensor elements allowing for the implementation of a flexible antenna, as will be described in greater detail below.

As will be appreciated in light of this disclosure, the techniques described herein may allow for improved reception and/or transmission of signals using self-configuring sensor arrays, compared to existing methods that either employ static array configurations or that require a manual reconfiguration which may not be possible or practical in many applications. The disclosed techniques can be implemented on a broad range of platforms including avionics and space platforms, such as satellites and unmanned aerial vehicles (UAVs). In some embodiments, the disclosed techniques can be implemented in support of ground-based applications. These techniques may further be implemented in hardware or software or a combination thereof.

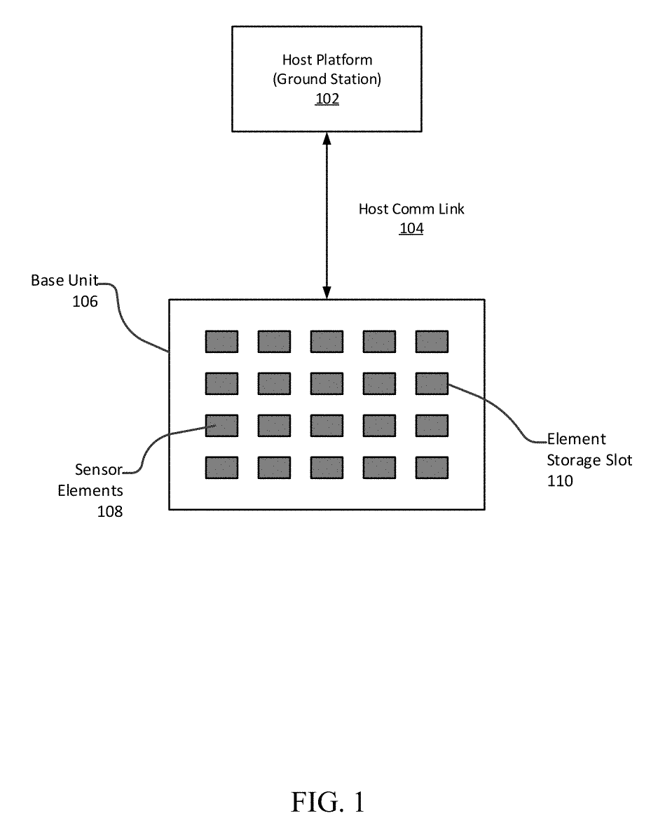

FIG. 1 illustrates a self-configuring sensor array system 100, prior to sensor deployment, in accordance with certain embodiments of the present disclosure. A base unit 106 is shown to store, house, or otherwise contain a number of mobile sensor elements 108 in element storage slots 110. In some embodiments, the base unit 106 may also be configured to recharge batteries in the mobile sensor elements 108 while they are in the storage slots 110.

In some embodiments, the base unit 106 and stored sensors 108 may be deployed on a mobile platform such as an avionics platform or space platform. In some embodiments, the deployment may be to a ground-based region of interest, including relatively inaccessible areas such as combat zones or otherwise inhospitable environments where manual configuration or adjustment of the deployed sensor array pattern would be difficult or impractical, although this need not be the case.

The base unit 106 is also shown to be communicatively coupled to a host platform or ground station 102 over a host communication link 104, as will be explained below. In some embodiments, the base unit 106 may be relatively remote with respect to the host platform 102, and the host communication link 104 is a wireless communications link.

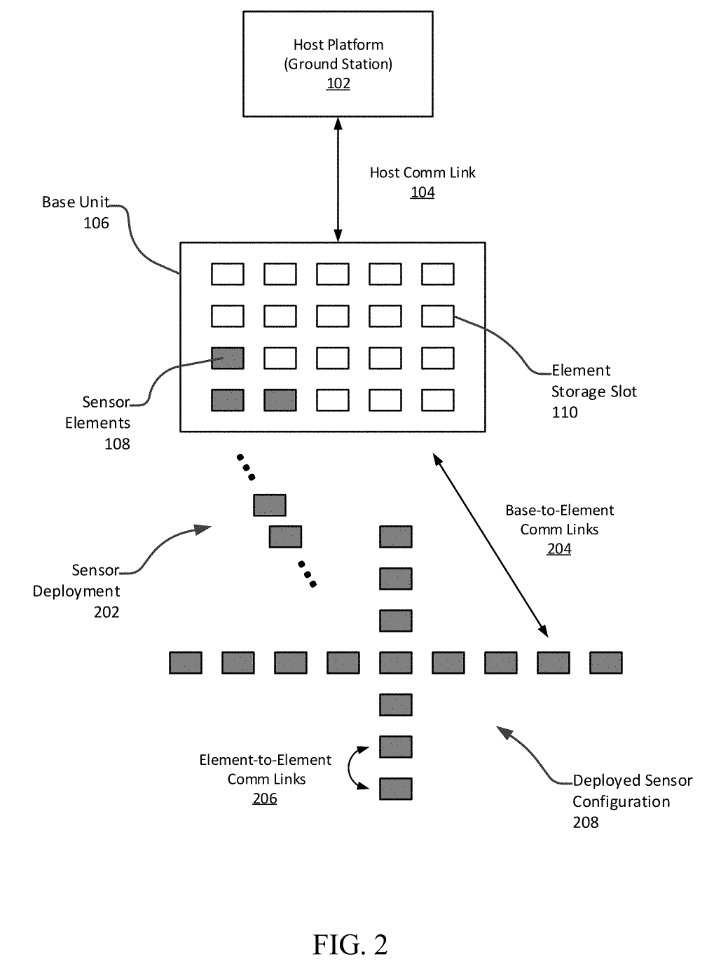

FIG. 2 illustrates an initial deployment 200 of the self-configuring sensor array, in accordance with certain embodiments of the present disclosure. FIG. 2 expands upon FIG. 1 by illustrating sensor deployment 202 from the base unit 106, leaving behind empty element storage slots 110. The self-propelled sensor elements 108 leave the base unit 106 and arrange themselves into an initial deployed sensor configuration 208, shown as a cross pattern in this example. In some embodiments, the initial pattern may be predetermined based on prior experience, experimental data, and/or previous deployments. For example, in some embodiments, the initial pattern may be a uniformly spaced grid.

The deployed sensor elements are shown to communicate with the base unit through a base-to-element communication link 204, and with each other through an element-to-element communications link 206. Communication links 204 and 206 may be wireless communication links, for example employing radio frequency (RF), infrared (IR), or other suitable transmission mechanisms.

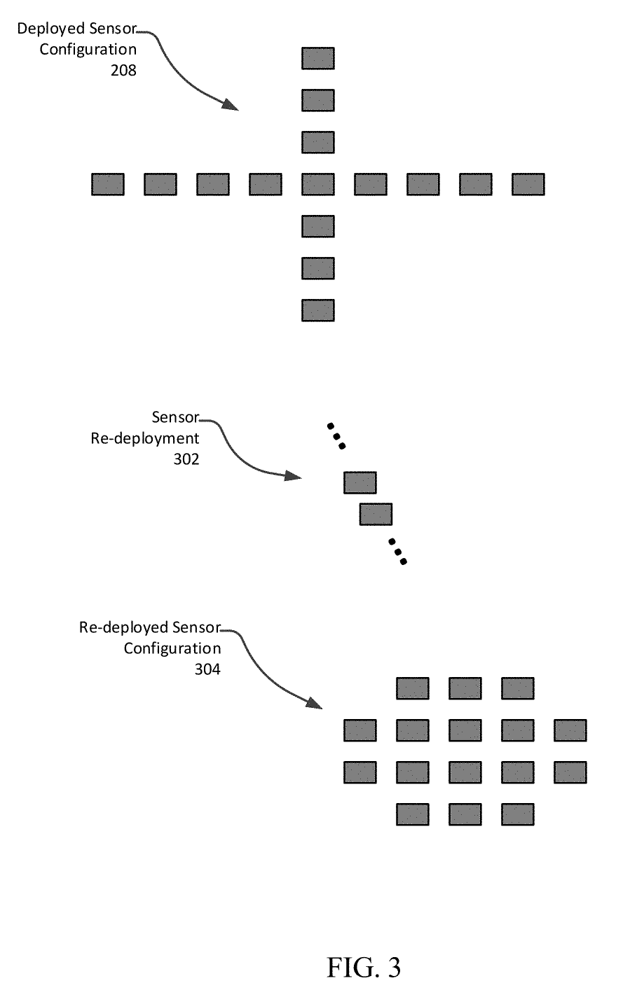

FIG. 3 illustrates a reconfiguration 300 of the self-configuring sensor array, in accordance with certain embodiments of the present disclosure. The example first deployed sensor configuration 208 is shown again as a cross pattern. Sensor redeployment 302 results in a second example of a redeployed sensor configuration 304 shown as a grid pattern within an elliptical perimeter. Of course, these are just two examples, and in practice the number of possible patterns that may be deployed and evaluated is unlimited.

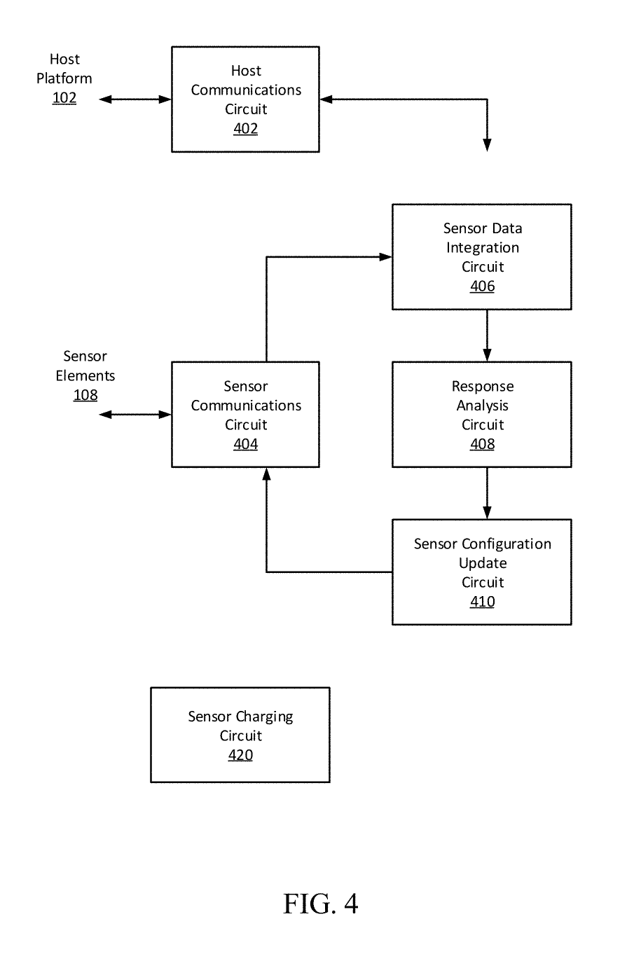

FIG. 4 is a block diagram of a sensor deploying base unit 106, configured in accordance with certain of the embodiments disclosed herein. The base unit 106 is shown to include a host communication circuit 402, a sensor communication circuit 404, a sensor data integration circuit 406, a response analysis circuit 408, a sensor configuration update circuit 410, and a sensor charging circuit 420.

The sensor communication circuit 404 is configured to provide communications between the base unit and the mobile sensor elements. These communications may include sensor configuration plans (including initial and updated plans), data received by the sensor elements, and/or signals to be transmitted by the sensor elements when the array is used as a transmitting antenna. For example, in some embodiments, transmitter elements may supplement (or substitute for) the sensor elements allowing for the implementation of a flexible antenna having an array pattern of transmitter elements that is tailored to a specific type of signal to be transmitted.

The sensor data integration circuit 406 is configured to integrate sensor data collected by each of the mobile sensor elements, after the mobile sensor elements navigate or redeploy to a calculated location based on the transmitted sensor configuration plan. In some embodiments, the calculated location is a 3-dimensional position that includes a height relative to a surface on which the mobile sensor elements are deployed.

The response analysis circuit 408 is configured to perform a response analysis based on the integrated sensor data. The response analysis is based on one or more variables associated with the sensor data. In some embodiments, the variables may include signal-to-noise ratio, dynamic range, phase alignment, and/or other known signal quality factors, in light of the present disclosure. For example, an undesirable phase alignment between the signals collected by different sensors may indicate that the spacing between sensors needs to be increased or decreased.

The sensor configuration update circuit 410 is configured to update the current sensor configuration plan based on a metric associated with the response analysis. The updates may comprise relatively small shifts in the locations of each sensor to provide additional response analysis data so that a local or global maximum may be found in the signal quality factors that can be associated with an optimal sensor array pattern. For example, if a particular configuration update result in improvement, the next update may continue further in that direction. On the other hand, if the update results in a degradation, the next update may proceed in a different direction.

The host communication circuit 402 is configured to transmit the integrated sensor data to a remote host platform, for example after the optimal/desired sensor array configuration has been determined and implemented. In some embodiments, the host platform may also provide instructions to begin or end operations or other instructions generally related to management of the system.

The sensor charging circuit 420 is configured to store the mobile sensor elements in the base unit, and charge the sensor batteries, prior to (or between) deployments. In some embodiments, the base unit, the sensors, or some combination thereof, may be configured to provide recharging capabilities using solar energy and/or other suitable energy harvesting techniques.

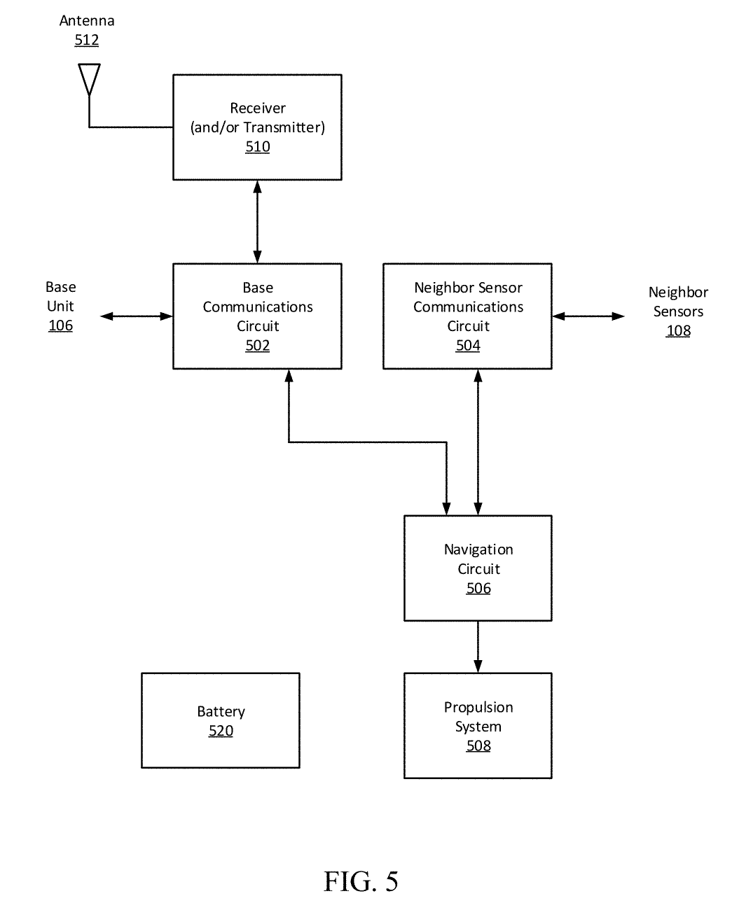

FIG. 5 is a block diagram of a mobile sensor element 108, configured in accordance with certain of the embodiments disclosed herein. The mobile sensor element 108 is shown to include a base communication circuit 502, a neighbor sensor communication circuit 504, an antenna 512, a receiver/transmitter 510, a navigation circuit 506, a propulsion system 508, and a battery 520.

The base communication circuit 502 is configured to receive a sensor configuration plan from the base unit. The base communication circuit is further configured to communicate the received signal of interest to the base unit, and/or obtain, from the base unit, a signal to be transmitted.

The neighbor sensor communication circuit 504 is configured to communicate with one or more neighbor mobile sensor elements to coordinate relative motion between the mobile sensor elements, for example to reduce congestion, avoid collisions. Neighbor sensor communication may also be used to refine the relative alignment of the sensors within the pattern to improve position and spacing accuracy.

The receiver/transmitter 510 is configured to receive and/or transmit a signal of interest, for example through antenna 512, by the mobile sensor element at the calculated location. In some embodiments, the antenna 512 may also be shared by communications circuits 502 and 504 for communications with the base unit and neighbor sensors respectively.

The navigation circuit 506 is configured to calculate a deployed location for the mobile sensor element, based on the sensor configuration plan. In some embodiments, the calculated location is a 3-dimensional position that includes a height relative to a surface on which the mobile sensor elements are deployed. In some embodiments, the height of the sensors relative to the surface on which they are deployed may be adjusted to achieve the desired 3-dimensional position. For example, extendable legs beneath the sensor may be used to adjust the height. The propulsion system 508 is configured to transport the mobile sensor element to the calculated location. For example, motor driven wheels or tracks may be used to propel the sensors. It will be appreciated that any other suitable methods or techniques may be used to propel the sensors and adjust their height, in light of the present disclosure.

The battery 520 is configured to provide power for operation of the mobile sensor elements (e.g., circuits and propulsion system). The battery may be charged by the base unit while the sensor elements are in their storage slots, prior to deployment of the mobile sensor elements from the base unit.

In some embodiments, one or more of the mobile sensor elements may be configured to provide at least some of the functionality of the base unit including host communication, sensor data integration, response analysis, and configuration updates, thus reducing or eliminating the need for the base unit. In some further embodiments, the base unit may be configured to perform the initial deployment of mobile sensor elements and then leave the region, after which the mobile sensor elements form an “ad hoc” network configured to perform distributed computations and work together as an integrated collection of sensor elements to provide at least a subset of the previously described functionality of the base unit.

Methodology

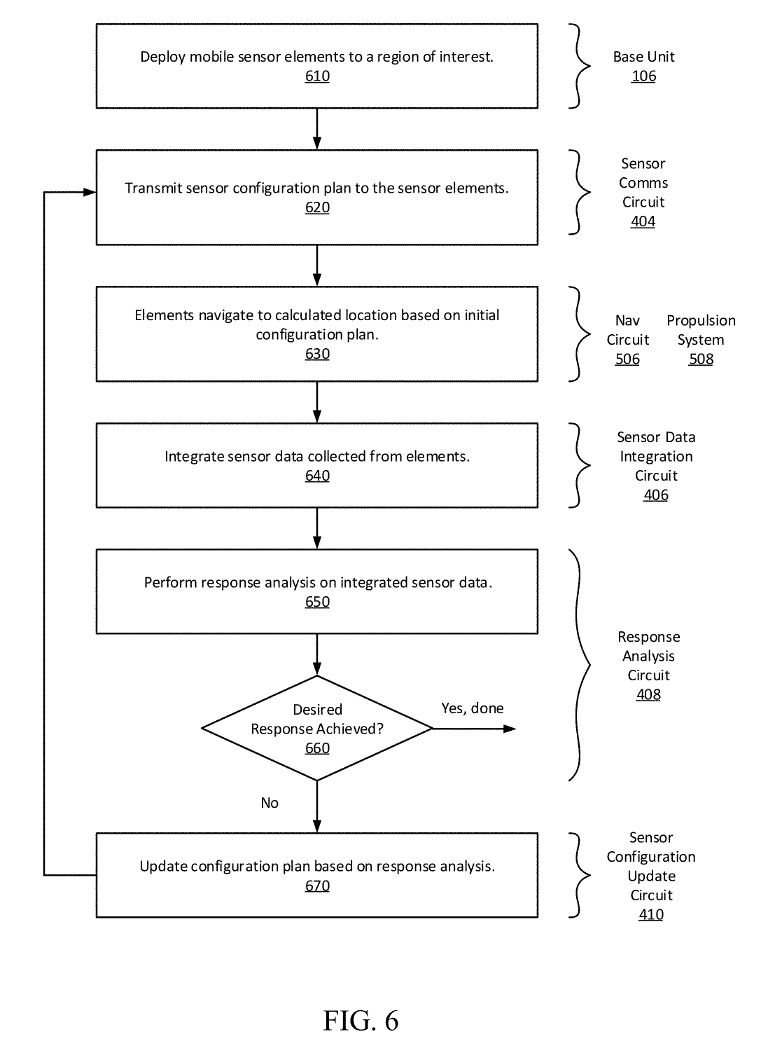

FIG. 6 is a flowchart illustrating an example method 600 for self-configuration of a sensor array, in accordance with certain embodiments of the present disclosure. Mobile sensor elements are deployed in a series of array configuration patterns to search for a configuration that results in a relatively optimal response. The mobile sensors navigate and self-propel themselves to appropriate locations for each pattern. As can be seen, the example method includes a number of phases and sub-processes, the sequence of which may vary from one embodiment to another. However, when considered in the aggregate, these phases and sub-processes form a process for sensor array self-configuration in accordance with certain of the embodiments disclosed herein. These embodiments can be implemented, for example using the system architecture illustrated in FIGS. 1-5 as described above. However other system architectures can be used in other embodiments, as will be apparent in light of this disclosure. To this end, the correlation of the various functions shown in FIG. 6 to the specific components illustrated in the other figures is not intended to imply any structural and/or use limitations. Rather, other embodiments may include, for example, varying degrees of integration wherein multiple functionalities are effectively performed by one system. For example, in an alternative embodiment a single module having decoupled sub-modules can be used to perform all of the functions of method 600. Thus, other embodiments may have fewer or more modules and/or sub-modules depending on the granularity of implementation. In still other embodiments, the methodology depicted can be implemented as a computer program product including one or more non-transitory machine readable mediums that when executed by one or more processors cause the methodology to be carried out. Numerous variations and alternative configurations will be apparent in light of this disclosure.

As illustrated in FIG. 6, in an embodiment, method 600 for self-configuration of a sensor array commences by deploying, at operation 610, a number of mobile sensor elements from a base unit to a region of interest. Next, at operation 620, an initial sensor configuration plan is transmitted by the base unit to the mobile sensor elements. In some embodiments, the initial plan may be a preselected plan known to provide acceptable results based on historical performance.

At operation 630, each of the mobile sensor elements navigate to a calculated location or position, for example using self-propulsion techniques. The calculated location is based on the initial sensor configuration plan. In some embodiments, the navigation process includes communicating between two or more of the mobile sensor elements to coordinate relative motion between the sensors.

At operation 640, sensor data is collected by each of the mobile sensor elements and transmitted to the base unit for integration. At operation 650, a response analysis is performed by the base unit. The response analysis is based on the integrated sensor data and may provide a metric or measurement of the quality of the response of the sensor array. In some embodiments, the response analysis is based on one or more variables associated with the sensor data, including, for example, signal-to-noise ratio, dynamic range, and phase alignment.

At operation 660, a determination is made, for example based on the metric, as to whether a desired response has been achieved from the array pattern of the current sensor configuration plan. If not, then at operation 670, the configuration plan is updated based on the response analysis, and the process is repeated, from operation 620, such that the sensors are redeployed using the new configuration plan.

Of course, in some embodiments, additional operations may be performed, as previously described in connection with the system. For example, the mobile sensor elements may also transmit signals of interest, and thus the self-configuring array may serve as a flexible antenna.

In some embodiments, the calculated location may be a 3-dimensional position that includes a height relative to a surface on which the mobile sensor elements are deployed. The sensors may achieve a specified height, for example, through the use of extendable and/or retractable legs or through other suitable means.

Example System

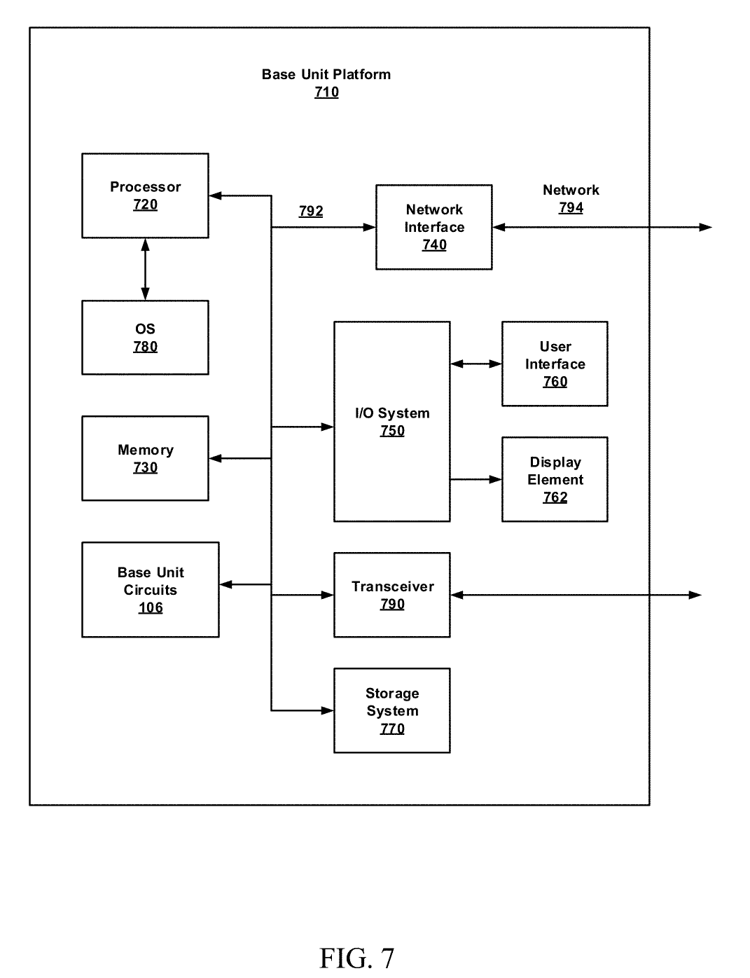

FIG. 7 illustrates an example system 700 configured to implement a self-configuring sensor array, in accordance with certain embodiments of the present disclosure. In some embodiments, system 700 comprises a computing or communications platform 710 which may serve as a base unit for deployment of mobile sensor elements.

In some embodiments, platform 710 may comprise any combination of a processor 720, a memory 730, base unit circuits 106, a network interface 740, an input/output (I/O) system 750, a user interface 760, a display element 762, a transceiver 790, and a storage system 770. As can be further seen, a bus and/or interconnect 792 is also provided to allow for communication between the various components listed above and/or other components not shown. Platform 710 can be coupled to a network 794 through network interface 740 to allow for communications with other computing devices, platforms, or resources. In some embodiments, network 794 may include the Internet. Other componentry and functionality not reflected in the block diagram of FIG. 7 will be apparent in light of this disclosure, and it will be appreciated that other embodiments are not limited to any particular hardware configuration.

Processor 720 can be any suitable processor, and may include one or more coprocessors or controllers, such as an audio processor, a graphics processing unit, or hardware accelerator, to assist in control and processing operations associated with system 700. In some embodiments, the processor 720 may be implemented as any number of processor cores. The processor (or processor cores) may be any type of processor, such as, for example, a micro-processor, an embedded processor, a digital signal processor (DSP), a graphics processor (GPU), a network processor, a field programmable gate array or other device configured to execute code. The processors may be multithreaded cores in that they may include more than one hardware thread context (or “logical processor”) per core. Processor 720 may be implemented as a complex instruction set computer (CISC) or a reduced instruction set computer (RISC) processor. In some embodiments, processor 720 may be configured as an x86 instruction set compatible processor.

Memory 730 can be implemented using any suitable type of digital storage including, for example, flash memory and/or random access memory (RAM). In some embodiments, the memory 730 may include various layers of memory hierarchy and/or memory caches as are known to those of skill in the art. Memory 730 may be implemented as a volatile memory device such as, but not limited to, a RAM, dynamic RAM (DRAM), or static RAM (SRAM) device. Storage system 770 may be implemented as a non-volatile storage device such as, but not limited to, one or more of a hard disk drive (HDD), a solid-state drive (SSD), a universal serial bus (USB) drive, an optical disk drive, tape drive, an internal storage device, an attached storage device, flash memory, battery backed-up synchronous DRAM (SDRAM), and/or a network accessible storage device. In some embodiments, storage 770 may comprise technology to increase the storage performance enhanced protection for valuable digital media when multiple hard drives are included.

Processor 720 may be configured to execute an Operating System (OS) 780 which may comprise any suitable operating system, such as Google Android (Google Inc., Mountain View, Calif.), Microsoft Windows (Microsoft Corp., Redmond, Wash.), Apple OS X (Apple Inc., Cupertino, Calif.), Linux, or a real-time operating system (RTOS). As will be appreciated in light of this disclosure, the techniques provided herein can be implemented without regard to the particular operating system provided in conjunction with system 700, and therefore may also be implemented using any suitable existing or subsequently-developed platform.

Network interface circuit 740 can be any appropriate network chip or chipset which allows for wired and/or wireless connection between other components of system 700 and/or network 794, thereby enabling system 700 to communicate with other local and/or remote computing systems, servers, cloud-based servers, and/or other resources. Wired communication may conform to existing (or yet to be developed) standards, such as, for example, Ethernet. Wireless communication may conform to existing (or yet to be developed) standards, such as, for example, cellular communications including LTE (Long Term Evolution), Wireless Fidelity (Wi-Fi), Bluetooth, and/or Near Field Communication (NFC). Exemplary wireless networks include, but are not limited to, wireless local area networks, wireless personal area networks, wireless metropolitan area networks, cellular networks, and satellite networks.

I/O system 750 may be configured to interface between various I/O devices and other components of system 700. I/O devices may include, but not be limited to, user interface 760 and display element 762. User interface 760 may include other devices (not shown) to facilitate user interaction with the platform for control and/or testing purposes. I/O system 750 may include a graphics subsystem configured to perform processing of images for rendering on the display element. Graphics subsystem may be a graphics processing unit or a visual processing unit (VPU), for example. An analog or digital interface may be used to communicatively couple graphics subsystem and the display element. For example, the interface may be any of a high definition multimedia interface (HDMI), DisplayPort, wireless HDMI, and/or any other suitable interface using wireless high definition compliant techniques. In some embodiments, the graphics subsystem could be integrated into processor 720 or any chipset of platform 710.

It will be appreciated that in some embodiments, the various components of the system 700 may be combined or integrated in a system-on-a-chip (SoC) architecture. In some embodiments, the components may be hardware components, firmware components, software components or any suitable combination of hardware, firmware or software.

Base unit circuits 106 are configured to deploy mobile sensor elements in a series of array configuration patterns to determine a configuration that results in a relatively optimal response from the sensors, as described previously. Base unit circuits 106 may include any or all of the circuits/components illustrated in FIGS. 1-5, as described above. These components can be implemented or otherwise used in conjunction with a variety of suitable software and/or hardware that is coupled to or that otherwise forms a part of platform 710. These components can additionally or alternatively be implemented or otherwise used in conjunction with user I/O devices that are capable of providing information to, and receiving information and commands from, a user.

In some embodiments, these circuits may be installed local to system 700, as shown in the example embodiment of FIG. 7. Alternatively, system 700 can be implemented in a client-server arrangement wherein at least some functionality associated with these circuits is provided to system 700 using an applet, such as a JavaScript applet, or other downloadable module or set of sub-modules. Such remotely accessible modules or sub-modules can be provisioned in real-time, in response to a request from a client computing system for access to a given server having resources that are of interest to the user of the client computing system. In such embodiments, the server can be local to network 794 or remotely coupled to network 794 by one or more other networks and/or communication channels. In some cases, access to resources on a given network or computing system may require credentials such as usernames, passwords, and/or compliance with any other suitable security mechanism.

In various embodiments, system 700 may be implemented as a wireless system, a wired system, or a combination of both. When implemented as a wireless system, system 700 may include components and interfaces suitable for communicating over a wireless shared media, such as one or more antennae, transmitters, receivers, transceivers, amplifiers, filters, control logic, and so forth. An example of wireless shared media may include portions of a wireless spectrum, such as the radio frequency spectrum and so forth. When implemented as a wired system, system 700 may include components and interfaces suitable for communicating over wired communications media, such as input/output adapters, physical connectors to connect the input/output adaptor with a corresponding wired communications medium, a network interface card (NIC), disc controller, video controller, audio controller, and so forth. Examples of wired communications media may include a wire, cable metal leads, printed circuit board (PCB), backplane, switch fabric, semiconductor material, twisted pair wire, coaxial cable, fiber optics, and so forth.

Various embodiments may be implemented using hardware elements, software elements, or a combination of both. Examples of hardware elements may include processors, microprocessors, circuits, circuit elements (for example, transistors, resistors, capacitors, inductors, and so forth), integrated circuits, ASICs, programmable logic devices, digital signal processors, FPGAs, logic gates, registers, semiconductor devices, chips, microchips, chipsets, and so forth. Examples of software may include software components, programs, applications, computer programs, application programs, system programs, machine programs, operating system software, middleware, firmware, software modules, routines, subroutines, functions, methods, procedures, software interfaces, application program interfaces, instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power level, heat tolerances, processing cycle budget, input data rates, output data rates, memory resources, data bus speeds, and other design or performance constraints.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still cooperate or interact with each other.

The various embodiments disclosed herein can be implemented in various forms of hardware, software, firmware, and/or special purpose processors. For example, in one embodiment at least one non-transitory computer readable storage medium has instructions encoded thereon that, when executed by one or more processors, cause one or more of the sensor array self-configuration methodologies disclosed herein to be implemented. The instructions can be encoded using a suitable programming language, such as C, C++, object oriented C, Java, JavaScript, Visual Basic .NET, Beginner's All-Purpose Symbolic Instruction Code (BASIC), or alternatively, using custom or proprietary instruction sets. The instructions can be provided in the form of one or more computer software applications and/or applets that are tangibly embodied on a memory device, and that can be executed by a computer having any suitable architecture. In one embodiment, the system can be hosted on a given website and implemented, for example, using JavaScript or another suitable browser-based technology. For instance, in certain embodiments, the system may leverage processing resources provided by a remote computer system accessible via network 794. The computer software applications disclosed herein may include any number of different modules, sub-modules, or other components of distinct functionality, and can provide information to, or receive information from, still other components. These modules can be used, for example, to communicate with input and/or output devices such as a display screen, a touch sensitive surface, a printer, and/or any other suitable device. Other componentry and functionality not reflected in the illustrations will be apparent in light of this disclosure, and it will be appreciated that other embodiments are not limited to any particular hardware or software configuration. Thus, in other embodiments system 700 may comprise additional, fewer, or alternative subcomponents as compared to those included in the example embodiment of FIG. 7.

The aforementioned non-transitory computer readable medium may be any suitable medium for storing digital information, such as a hard drive, a server, a flash memory, and/or random access memory (RAM), or a combination of memories. In alternative embodiments, the components and/or modules disclosed herein can be implemented with hardware, including gate level logic such as a field-programmable gate array (FPGA), or alternatively, a purpose-built semiconductor such as an application-specific integrated circuit (ASIC). Still other embodiments may be implemented with a microcontroller having a number of input/output ports for receiving and outputting data, and a number of embedded routines for carrying out the various functionalities disclosed herein. It will be apparent that any suitable combination of hardware, software, and firmware can be used, and that other embodiments are not limited to any particular system architecture.

Some embodiments may be implemented, for example, using a machine readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, process, or the like, and may be implemented using any suitable combination of hardware and/or software. The machine readable medium or article may include, for example, any suitable type of memory unit, memory device, memory article, memory medium, storage device, storage article, storage medium, and/or storage unit, such as memory, removable or non-removable media, erasable or non-erasable media, writeable or rewriteable media, digital or analog media, hard disk, floppy disk, compact disk read only memory (CD-ROM), compact disk recordable (CD-R) memory, compact disk rewriteable (CR-RW) memory, optical disk, magnetic media, magneto-optical media, removable memory cards or disks, various types of digital versatile disk (DVD), a tape, a cassette, or the like. The instructions may include any suitable type of code, such as source code, compiled code, interpreted code, executable code, static code, dynamic code, encrypted code, and the like, implemented using any suitable high level, low level, object oriented, visual, compiled, and/or interpreted programming language.

Unless specifically stated otherwise, it may be appreciated that terms such as “processing,” “computing,” “calculating,” “determining,” or the like refer to the action and/or process of a computer or computing system, or similar electronic computing device, that manipulates and/or transforms data represented as physical quantities (for example, electronic) within the registers and/or memory units of the computer system into other data similarly represented as physical quantities within the registers, memory units, or other such information storage transmission or displays of the computer system. The embodiments are not limited in this context.

The terms “circuit” or “circuitry,” as used in any embodiment herein, are functional and may comprise, for example, singly or in any combination, hardwired circuitry, programmable circuitry such as computer processors comprising one or more individual instruction processing cores, state machine circuitry, and/or firmware that stores instructions executed by programmable circuitry. The circuitry may include a processor and/or controller configured to execute one or more instructions to perform one or more operations described herein. The instructions may be embodied as, for example, an application, software, firmware, etc. configured to cause the circuitry to perform any of the aforementioned operations. Software may be embodied as a software package, code, instructions, instruction sets and/or data recorded on a computer-readable storage device. Software may be embodied or implemented to include any number of processes, and processes, in turn, may be embodied or implemented to include any number of threads, etc., in a hierarchical fashion. Firmware may be embodied as code, instructions or instruction sets and/or data that are hard-coded (e.g., nonvolatile) in memory devices. The circuitry may, collectively or individually, be embodied as circuitry that forms part of a larger system, for example, an integrated circuit (IC), an application-specific integrated circuit (ASIC), a system-on-a-chip (SoC), desktop computers, laptop computers, tablet computers, servers, smart phones, etc. Other embodiments may be implemented as software executed by a programmable control device. In such cases, the terms “circuit” or “circuitry” are intended to include a combination of software and hardware such as a programmable control device or a processor capable of executing the software. As described herein, various embodiments may be implemented using hardware elements, software elements, or any combination thereof. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth.

Numerous specific details have been set forth herein to provide a thorough understanding of the embodiments. It will be understood by an ordinarily-skilled artisan, however, that the embodiments may be practiced without these specific details. In other instances, well known operations, components and circuits have not been described in detail so as not to obscure the embodiments. It can be appreciated that the specific structural and functional details disclosed herein may be representative and do not necessarily limit the scope of the embodiments. In addition, although the subject matter has been described in language specific to structural features and/or methodological acts, it is to be understood that the subject matter defined in the appended claims is not necessarily limited to the specific features or acts described herein. Rather, the specific features and acts described herein are disclosed as example forms of implementing the claims.

### FURTHER EXAMPLE EMBODIMENTS

The following examples pertain to further embodiments, from which numerous permutations and configurations will be apparent.

One example embodiment of the present disclosure provides a method for self-configuration of a sensor array: The method includes: deploying, from a base unit, a plurality of mobile sensor elements to a region of interest; transmitting, by the base unit, an initial sensor configuration plan to the mobile sensor elements; navigating, by each of the mobile sensor elements, to a calculated location based on the initial sensor configuration plan; integrating, by the base unit, sensor data collected by each of the mobile sensor elements, the sensor data transmitted from the mobile sensor elements to the base unit; performing, by the base unit, a response analysis based on the integrated sensor data; updating, by the base unit, the initial sensor configuration plan based on a metric associated with the response analysis; and iterating the method, employing the updated sensor configuration plan.

In some cases, the method further includes performing additional iterations until the metric reaches a selected threshold value. In some cases, the response analysis is based on a plurality of variables, the variables associated with the sensor data, the variables including one or more of signal-to-noise ratio, dynamic range, and phase alignment. In some cases, the navigating further includes communicating between two or more of the mobile sensor elements to coordinate relative motion between the mobile sensor elements. In some cases, the method further includes storing the plurality of mobile sensor elements in the base unit prior to deployment, and providing, by the base unit, a charging capability for the sensor elements in storage. In some cases, the method further includes transmitting, by the base unit, the integrated sensor data to a remote host platform. In some cases, the calculated location is a 3-dimensional position that includes a height relative to a surface on which the mobile sensor elements are deployed. In some cases, the method further includes transmitting, by the mobile sensor elements, a signal provided by the base unit. In some cases, the method further includes deploying the mobile sensor elements on an avionics platform. In some cases, the method further includes deploying the mobile sensor elements in a ground-based application.

Another example embodiment of the present disclosure provides a self-configuring sensor array system. The system includes: a base unit to deploy a plurality of mobile sensor elements to a region of interest; a sensor communications circuit to transmit an initial sensor configuration plan to the mobile sensor elements; a sensor data integration circuit to integrate sensor data collected by each of the mobile sensor elements, after the mobile sensor elements navigate to a calculated location based on the initial sensor configuration plan; a response analysis circuit to perform a response analysis based on the integrated sensor data; a sensor configuration update circuit to update the initial sensor configuration plan based on a metric associated with the response analysis; and the self-configuring sensor array system to iterate the process, employing the updated sensor configuration plan, until the metric reaches a selected threshold value.

In some cases, the response analysis is based on a plurality of variables, the variables associated with the sensor data, the variables including one or more of signal-to-noise ratio, dynamic range, and phase alignment. In some cases, the system further includes a sensor charging circuit to store and charge the plurality of mobile sensor elements in the base unit prior to deployment. In some cases, the system further includes a host communications circuit to transmit the integrated sensor data to a remote host platform. In some cases, the calculated location is a 3-dimensional position that includes a height relative to a surface on which the mobile sensor elements are deployed

Another example embodiment of the present disclosure provides a self-configuring sensor array system. The system includes: a plurality of mobile sensor elements communicatively coupled to a base unit, each of the mobile sensor elements further including: a base communication circuit to receive a sensor configuration plan from the base unit; a navigation circuit to calculate a deployed location for the mobile sensor element, based on the sensor configuration plan; a propulsion system to transport the mobile sensor element to the calculated location; and a receiver circuit to receive a signal of interest by the mobile sensor element, at the calculated location.

In some cases, the mobile sensor elements are to deploy from the base unit to a region of interest. In some cases, the mobile sensor elements further include a neighbor sensor communications circuit to communicate with one or more neighbor mobile sensor elements to coordinate relative motion between the mobile sensor elements. In some cases, the base communication circuit is further to communicate the received signal of interest to the base unit. In some cases, the calculated location is a 3-dimensional position that includes a height relative to a surface on which the mobile sensor elements are deployed. In some cases, the mobile sensor elements further include a transmitter circuit to transmit a signal provided by the base unit through the base communication circuit. In some cases, the mobile sensor elements further include a battery to provide power for operation of the mobile sensor elements, the battery to be charged by the base unit prior to deployment of the mobile sensor elements. In some cases, the mobile sensor elements are deployed on an avionics platform. In some cases, the mobile sensor elements are deployed in a ground-based application. In some cases, one or more of the mobile sensor elements are configured to serve as the base unit.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents. Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications. It is intended that the scope of the present disclosure be limited not be this detailed description, but rather by the claims appended hereto. Future filed applications claiming priority to this application may claim the disclosed subject matter in a different manner, and may generally include any set of one or more elements as variously disclosed or otherwise demonstrated herein.

What is claimed is:

1. A method for self-configuration of a sensor array, the method comprising:
deploying, from a base unit, a plurality of mobile sensor elements to a region of interest;
transmitting, by the base unit, an initial sensor configuration plan to the mobile sensor elements;
navigating, by each of the mobile sensor elements, to a calculated location based on the initial sensor configuration plan;
integrating, by the base unit, sensor data collected by each of the mobile sensor elements, the sensor data transmitted from the mobile sensor elements to the base unit;
performing, by the base unit, a response analysis based on the integrated sensor data;
updating, by the base unit, the initial sensor configuration plan based on a metric associated with the response analysis; and
iterating the method, employing the updated sensor configuration plan.

2. The method of claim 1, further comprising performing additional iterations until the metric reaches a selected threshold value.

3. The method of claim 1, wherein the response analysis is based on a plurality of variables, the variables associated with the sensor data, the variables including one or more of signal-to-noise ratio, dynamic range, and phase alignment.

4. The method of claim 1, wherein the navigating further comprises communicating between two or more of the mobile sensor elements to coordinate relative motion between the mobile sensor elements.

5. The method of claim 1, further comprising storing the plurality of mobile sensor elements in the base unit prior to deployment, and providing, by the base unit, a charging capability for the sensor elements in storage.

6. The method of claim 1, further comprising transmitting, by the base unit, the integrated sensor data to a remote host platform.

7. The method of claim 1, wherein the calculated location is a 3-dimensional position that includes a height relative to a surface on which the mobile sensor elements are deployed.

8. The method of claim 1, further comprising transmitting, by the mobile sensor elements, a signal provided by the base unit.

9. The method of claim 1, further comprising deploying the mobile sensor elements on an avionics platform.

10. The method of claim 1, further comprising deploying the mobile sensor elements in a ground-based application.

11. A self-configuring sensor array system, the system comprising:
a base unit to deploy a plurality of mobile sensor elements to a region of interest;
a sensor communications circuit to transmit an initial sensor configuration plan to the mobile sensor elements;
a sensor data integration circuit to integrate sensor data collected by each of the mobile sensor elements, after the mobile sensor elements navigate to a calculated location based on the initial sensor configuration plan;
a response analysis circuit to perform a response analysis based on the integrated sensor data;
a sensor configuration update circuit to update the initial sensor configuration plan based on a metric associated with the response analysis; and
the self-configuring sensor array system to iterate the process, employing the updated sensor configuration plan, until the metric reaches a selected threshold value.

12. The system of claim 11, wherein the response analysis is based on a plurality of variables, the variables associated with the sensor data, the variables including one or more of signal-to-noise ratio, dynamic range, and phase alignment.

13. The system of claim 11, further comprising a sensor charging circuit to store and charge the plurality of mobile sensor elements in the base unit prior to deployment.

14. The system of claim 11, further comprising a host communications circuit to transmit the integrated sensor data to a remote host platform.

15. The system of claim 11, wherein the calculated location is a 3-dimensional position that includes a height relative to a surface on which the mobile sensor elements are deployed.

16. A self-configuring sensor array system, the system comprising:
a plurality of mobile sensor elements communicatively coupled to a base unit, each of the mobile sensor elements further comprising:
a base communication circuit to receive a sensor configuration plan from the base unit;
a navigation circuit to calculate a deployed location for the mobile sensor element, based on the sensor configuration plan;
a propulsion system to transport the mobile sensor element to the calculated location; and
a receiver circuit to receive a signal of interest by the mobile sensor element, at the calculated location.

17. The system of claim 16, wherein the mobile sensor elements are to deploy from the base unit to a region of interest.

18. The system of claim 16, wherein the mobile sensor elements further comprise a neighbor sensor communications circuit to communicate with one or more neighbor mobile sensor elements to coordinate relative motion between the mobile sensor elements.

19. The system of claim 16, wherein the base communication circuit is further to communicate the received signal of interest to the base unit.

20. The system of claim 16, wherein the calculated location is a 3-dimensional position that includes a height relative to a surface on which the mobile sensor elements are deployed.

21. The system of claim 16, wherein the mobile sensor elements further comprise a transmitter circuit to transmit a signal provided by the base unit through the base communication circuit.

22. The system of claim 16, wherein the mobile sensor elements further comprise a battery to provide power for operation of the mobile sensor elements, the battery to be charged by the base unit prior to deployment of the mobile sensor elements.

23. The system of claim 16, wherein the mobile sensor elements are deployed on an avionics platform.

24. The system of claim 16, wherein the mobile sensor elements are deployed in a ground-based application.

25. The system of claim 16, wherein one or more of the mobile sensor elements are to serve as the base unit.
